(19) United States
(12) Patent Application Publication
(10) Pub. No.: US 2024/0205255 A1
(43) Pub. Date: Jun. 20, 2024

(54) THREAT AWARE SERVICE MESH

(71) Applicant: INTERNATIONAL BUSINESS MACHINES CORPORATION, Armonk, NY (US)

(72) Inventors: Sudheesh S. Kairali, Kozhikode (IN); Sarbajit K. Rakshit, Kolkata (IN)

(21) Appl. No.: 18/065,929

(22) Filed: Dec. 14, 2022

(51) Int. Cl. H04L 9/40

(52) U.S. Cl. CPC H04L 63/1433; H04L 63/20

(57) ABSTRACT

A computer-implemented method for providing a threat aware service mesh is provided. The method includes extending the threat aware service mesh to accept, in a control plane of the threat aware service mesh, a plugin threat modeling management resource for managing threat model details. The method further includes automatically re-arranging a network policy related to a given service responsive to a high severity vulnerability above a threshold and an associated threat probability being marked against the given service. The method also includes performing a threshold based optimization of removing a particular service from a network policy allowed list responsive to one or more threats against the particular service at one of more different threat levels above a threshold. The method additionally includes assigning default not-allowed policies and only allowing access to restricted services for trust boundaries marked in a threat model of the threat aware service mesh.

### BACKGROUND

The present invention generally relates to threat modeling, and more particularly to a threat aware service mesh.

The replacement of legacy services to microservices has put forth a lot of new challenges. Lots of data and learning gets transferred between many microservices in a cloud based environment. Services meshes such as ISTIO abstract traffic related complexities in a control plane and data plane. A service mesh is a mesh of all services whose proxies will interact with each other.

Threat modeling is a procedure for optimizing application, system, or business process security by identifying objectives and vulnerabilities, and then defining countermeasures to prevent or mitigate the effects of threats to the system.

Threat model primary concerns are: (1) trust boundaries (incoming and outgoing); (2) data flow and data stores; and (3) service code. When a security architect identifies possible threats, they can mark these threats into threat models. However, when a system architect deploys services in a service mesh, the preceding three concerns need to be manually considered. This disconnect creates tangible problems. For example, in iteration 1, microservice 2 receives communication from microservice 1 an microservice 3 and as per the threat model, microservice 3 has a threat which probably becomes a risk in the near future, microservice 1 should not be allow connection from microservice 3. However, currently such network policy changes are done manually.

### SUMMARY

According to aspects of the present invention, a computer-implemented method for providing a threat aware service mesh is provided. The method includes extending the threat aware service mesh to accept, in a control plane of the threat aware service mesh, a plugin threat modeling management resource for managing threat model details. The method further includes automatically re-arranging a network policy related to a given service responsive to a high severity vulnerability above a threshold and an associated threat probability being marked against the given service. The method also includes performing a threshold based optimization of removing a particular service from a network policy allowed list responsive to one or more threats against the particular service at one of more different threat levels above a threshold. The method additionally includes assigning default not-allowed policies and only allowing access to restricted services for trust boundaries marked in a threat model of the threat aware service mesh.

According to other aspects of the present invention, a computer-implemented method for providing a threat aware service mesh is provided. The method includes extending the threat aware service mesh with a service mesh Application Programming Interface (API) and threat model management system in a control plane of the threat aware service mesh. The method further includes automatically re-arranging a network policy related to a given service responsive to a high severity vulnerability above a threshold and an associated threat probability being marked against the given service. The method also includes performing a threshold based optimization of removing a particular service from a network policy allowed list responsive to one or more threats against the particular service at one of more different threat levels above a threshold. The method additionally includes assigning default not-allowed policies and only allowing access to restricted services for trust boundaries marked in a threat model of the threat aware service mesh.

According to still further aspects of the present invention, a computer program product for providing a threat aware service mesh is provided. The computer program product includes a non-transitory computer readable storage medium having program instructions embodied therewith. The program instructions are executable by a computer to cause the computer to perform a method. The method includes extending, by a hardware processor of the computer, the threat aware service mesh to accept, in a control plane of the threat aware service mesh, a plugin threat modeling management resource for managing threat model details. The method further includes automatically re-arranging, by the hardware processor, a network policy related to a given service responsive to a high severity vulnerability above a threshold and an associated threat probability being marked against the given service. The method also includes performing, by the hardware processor, a threshold based optimization of removing a particular service from a network policy allowed list responsive to one or more threats against the particular service at one of more different threat levels above a threshold. The method additionally includes assigning, by the hardware processor, default not-allowed policies and only allowing access to restricted services for trust boundaries marked in a threat model of the threat aware service mesh.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing a computing environment, in accordance with an embodiment of the present invention;

FIG. 2 is a block diagram showing an exemplary service mesh architecture to which the present invention can be applied, in accordance with an embodiment of the present invention;

FIG. 3 is a block diagram showing an exemplary service mesh configuration, in accordance with an embodiment of the present invention;

FIGS. 4-5 is a flow diagram extending to two sheets showing an exemplary method for providing a threat aware service mesh, in accordance with an embodiment of the present invention; and

FIGS. 6-7 is a flow diagram extending to two sheets showing another exemplary method for providing a threat aware service mesh, in accordance with an embodiment of the present invention.

### DETAILED DESCRIPTION

Embodiments of the present invention relate to a threat aware service mesh.

One or more embodiments of the present invention are directed to a threat aware service mesh that allows threat model details to be added to the control plane.

One or more embodiments of the present invention are directed to a threat aware service mesh having trust boundaries and data flow controls based on the threat model.

One or more embodiments of the present invention are directed to a threat aware service mesh using risk-based isolation.

One or more embodiments of the present invention are directed to a threat aware service mesh that can implement new service policies.

One or more embodiments of the present invention are directed to a threat aware service mesh using rule-based automatic isolation for risky services.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

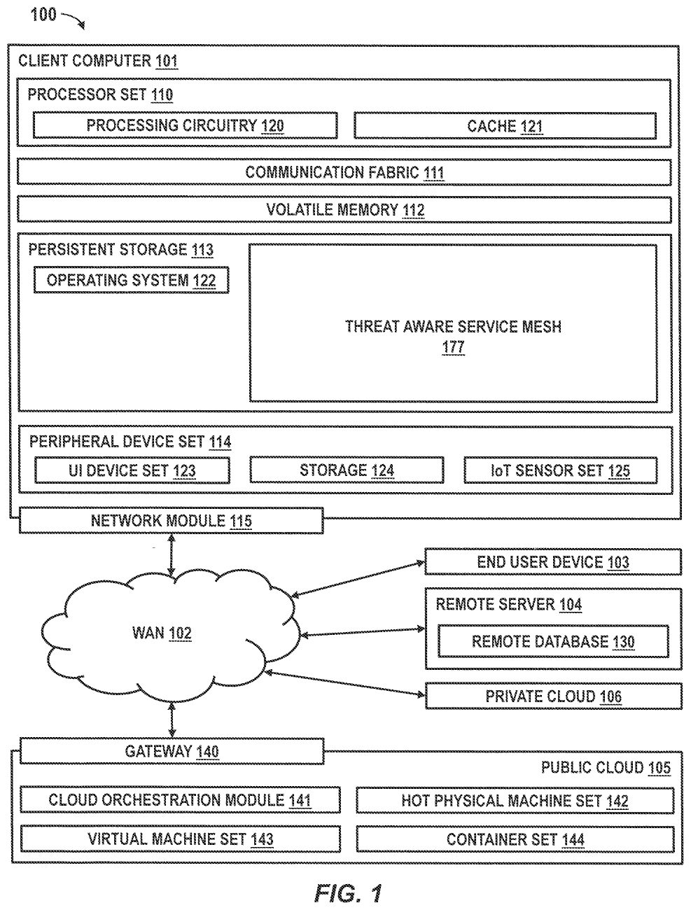

FIG. 1 is a block diagram of a computing environment 100, in accordance with an embodiment of the present invention.

Computing environment 100 contains an example of an environment for the execution of at least some of the computer code involved in performing the inventive methods, such as providing a threat aware service mesh. In addition to block 177, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 177, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 177 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 177 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A description will now be given regarding service meshes, in accordance with an embodiment of the present invention.

A service mesh is a dedicated infrastructure layer that controls service-to-service communication over a network. A service mesh enables separate parts of an application to communicate with each other. Service meshes appear commonly in concert with cloud-based applications, containers and microservices.

A service mesh controls the delivery of service requests in an application. Common features provided by a service mesh include service discovery, load balancing, encryption and failure recovery.

A service mesh architecture uses a proxy instance called a sidecar in whichever development paradigm is in use, typically containers and/or microservices. In a microservice application, a sidecar attaches to each service.

Service instances, sidecars and their interactions make up what is called the data plane in a service mesh. A different layer called the control plane manages tasks such as creating instances, monitoring and implementing policies for network management and security. Control planes can connect to a CLI or a GUI interface for application management.

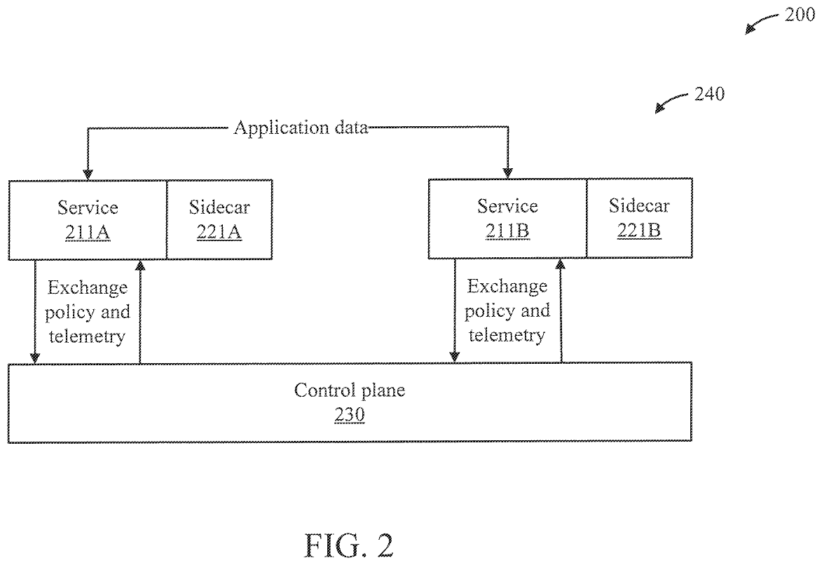

FIG. 2 is a block diagram showing an exemplary service mesh architecture 200 to which the present invention can be applied, in accordance with an embodiment of the present invention;

The service mesh architecture 200 includes a set of services 210. In the example of FIG. 2, the set of services 210 include a first service 210A and a second service 210B. A first sidecar 221A is attached to the first service 210A, and a second sidecar 221B is attached to the second service.

Application data is exchanged between the first service 210A and the second service 210B. Policy and telemetry data are exchanged between the first service 210A and a control plane 230, and between the second service 210B and the control plane 230. The services 210A and 210B, sidecars 211A and 211B, and their interactions form a data plane 240 in the service mesh.

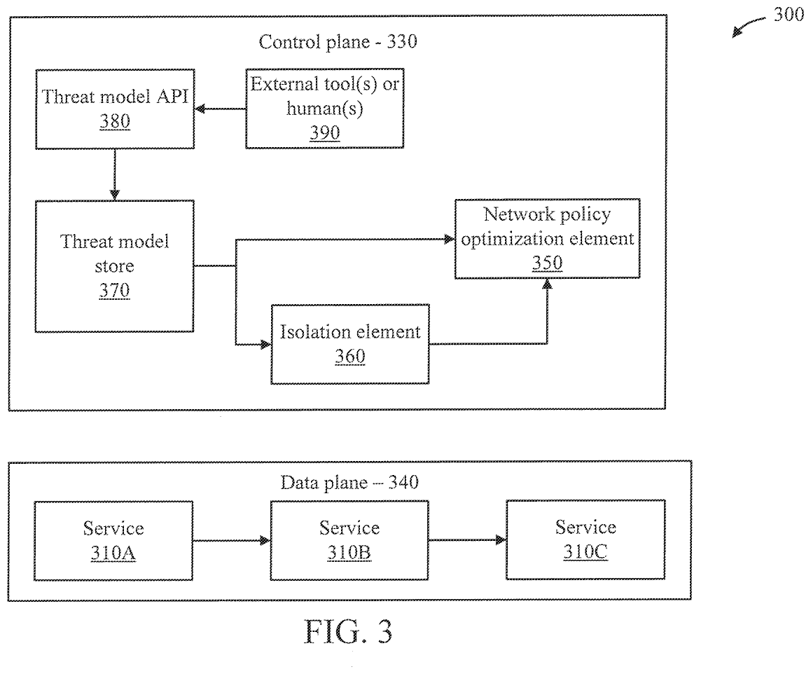

FIG. 3 is a block diagram showing an exemplary configuration 300, in accordance with an embodiment of the present invention.

The configuration 300 includes a control plane 330 and a data plane 340.

The data plane 340 includes a first service 310A, a second service 310B, and a third service 310C.

The control plane 330 includes a network policy optimization element 350, and isolation element 360, a threat model store 370, a threat model Application Programming Interface (API) 380, and an external tool(s) and/or a human(s) 390.

The isolation element 360 can impose permanent or time limited isolation. The isolation can be imposed based on a risk(s) and/or a rule(s).

The threat model store 370 can store a threat model and its parameters including, but not limited to, a service names, threat details, remedial plans, risk details, trust boundary details, and so forth.

Embodiments of the present invention are directed to a threat aware service mesh. The threat aware service mesh can be extended to allow for the adding of threat model details in the control plane in 2 ways.

One way for adding threat model details in the control plane involves an extension that allows to plugin threat modelling tools or external threat modelling management systems. The service mesh will provide the ability to push threat model information from other tools such as Threat Dragon.

Another way for adding threat model details in the control plane is to provide the service mesh with its own API and threat model management system. By this way, the threat model can be devised.

Vulnerabilities, risks, threats, and so forth can be marked. Assets will be services in the service mesh. The name of a service in the threat model and the service mesh should match for automatic policy enhancement.

A description will now be given regarding trust boundaries and data flow controls based on a threat model, in accordance with an embodiment of the present invention.

The service mesh will extend its default network policies by considering threat model information

If a high severity vulnerability and an associated threat probability is marked against a service, then the service mesh will re arrange network policy related to this service automatically (e.g., if an administrator has enabled such an optimization).

If service 1 is having multiple sev1 threats, and if service 2 was having service 1 in its network policy allowed list, then service 1 will be removed from the list. This could be a threshold-based optimization such as: at least 1 high severity vulnerability/threat or at least 2 medium threats, and so forth.

Trust boundaries marked in the threat model will have default NOT-ALLOWED policies assigned and only will be allowed to restricted services. For e.g.: if service 2 is marked as a trust boundary, and as per threat model only service 1 is safe to communicate with service 2, then network policy will be generated accordingly. All the trust boundaries in the system will get similar treatment.

If data flow is marked between service 1 and service 2, then a mutual Transport Layer Security (TLS) could automatically be enabled between these 2 services.

A description will now be given regarding threat model risked based isolation in the service mesh, in accordance with an embodiment of the present invention.

Any threat that is already exploited or suspected to be exploited is called as a risk as per the threat model. So, if a risk is marked against Service 1, then that service could be network isolated (if such an optimization is enabled). This essentially means a business outage, but this would reduce the damage in critical situations. This gives a less technically aware security architect a very useful choice in a real field scenario.

Time limited Risks: Risks could be time limited. For example, a firewall is down for 24 hours, and a security architect could mark a risk against Service 2, Service 3, and Service 4 for 24 hours.

Risks could be uploaded and removed programmatically by authorized external systems to the service mesh.

A description will now be given regarding new services policies, in accordance with an embodiment of the present invention.

New services policies: If a new service 4 is deployed and service 2 and service 3 are communicating to this service, then the service mesh could isolate the network policies which are common for all receiving services that receive traffic from service 2, and service 3 could be applied to service 4.

A description will now be given regarding rule based automatic isolation for risky services.

Rule base automatic Isolation for risky services: If a service 1 is handling a trust boundary and has 5 high threats, then a configuration can be made in such a way that automatic network isolation of this service will be done if: (a) traffic crosses threshold; (b) exhibits restarts beyond threshold; and (c) other rules admin wants to write.

This can be interlinked to the remediation plans that are recorded in the threat model as well.

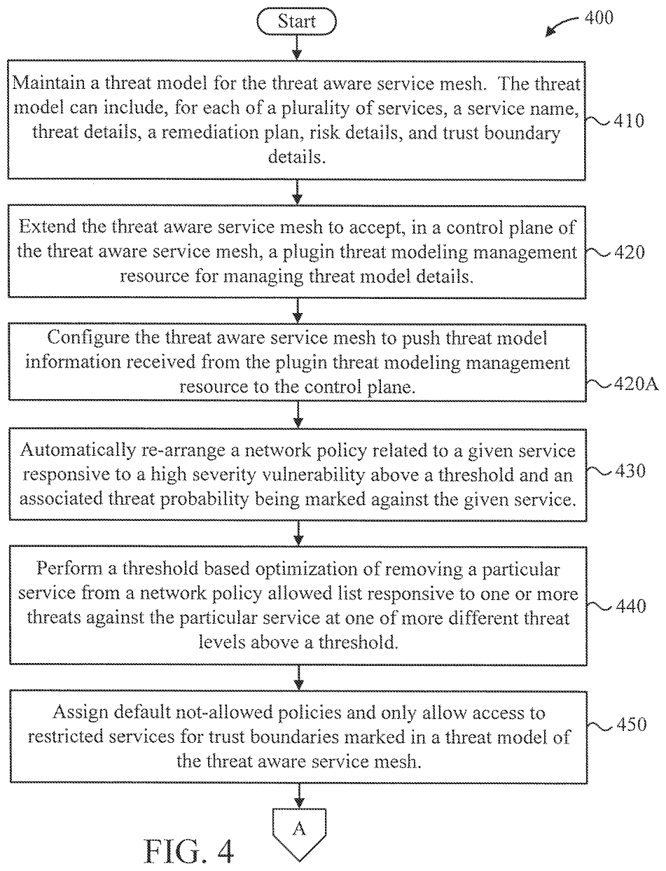

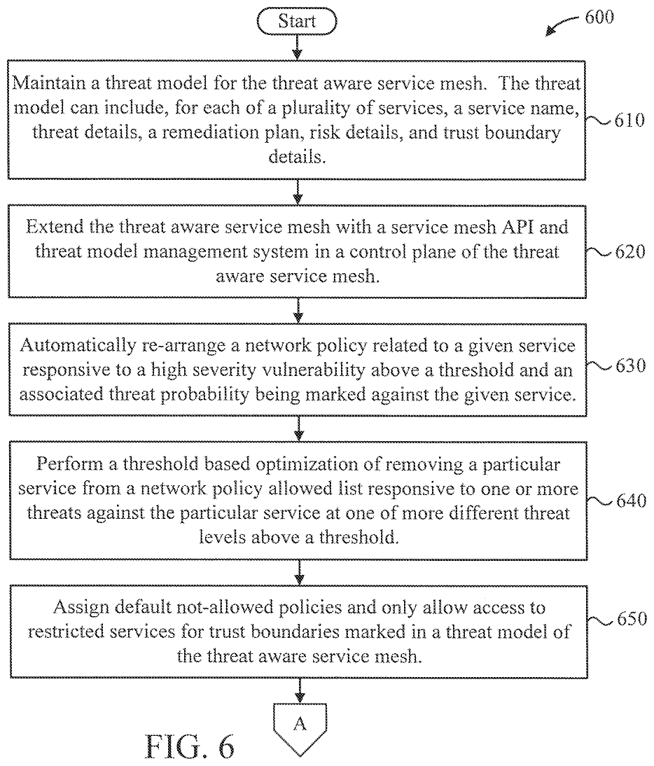

Exemplary methods for providing a threat aware service mesh are shown in FIGS. 4-5 and 6-7. The difference between the methods lies in how the threat aware service mesh is extended in blocks 420 and 520 in FIGS. 4 and 6, respectively.

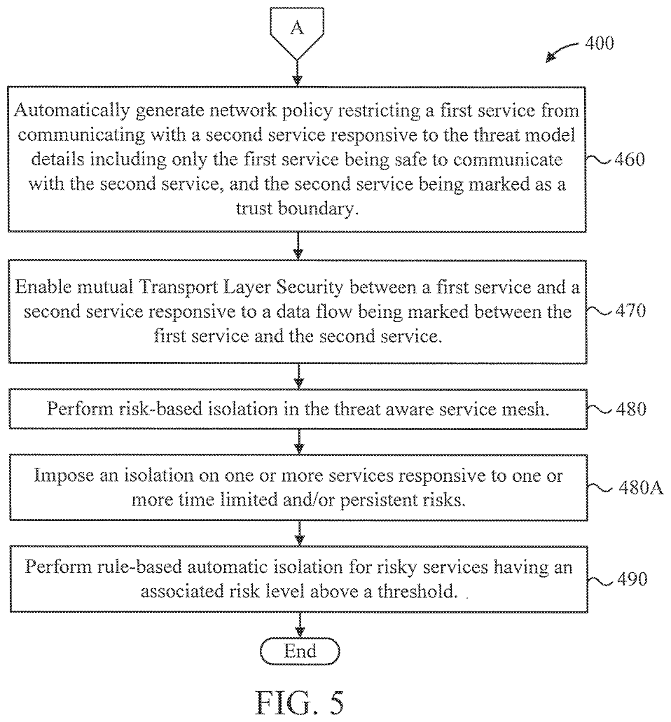

FIGS. 4-5 are flow diagrams showing an exemplary method 400 for providing a threat aware service mesh, in accordance with an embodiment of the present invention.

At block 410, maintain a threat model for the threat aware service mesh. The threat model can include, for each of a plurality of services, a service name, threat details, a remediation plan, risk details, and trust boundary details.

At block 420, extend the threat aware service mesh to accept, in a control plane of the threat aware service mesh, a plugin threat modeling management resource for managing threat model details.

In an embodiment, block 420 can include block 420A.

At block 420A, configure the threat aware service mesh to push threat model information received from the plugin threat modeling management resource to the control plane.

At block 430, automatically re-arrange a network policy related to a given service responsive to a high severity vulnerability above a threshold and an associated threat probability being marked against the given service. The re-arrangement can involve, for example, restricting the service from communicating with other services.

At block 440, perform a threshold based optimization of removing a particular service from a network policy allowed list responsive to one or more threats against the particular service at one of more different threat levels above a threshold. For example, the particular service could have a high severity threat level or 2 medium severity threat levels that could cause block 440 to be performed.

At block 450, assign default not-allowed policies and only allow access to restricted services for trust boundaries marked in a threat model of the threat aware service mesh.

In an embodiment, block 450 can include block 450A.

At block 450A, automatically generate network policy restricting a first service from communicating with a second service responsive to the threat model details including only the first service being safe to communicate with the second service, and the second service being marked as a trust boundary.

At block 460, enable mutual Transport Layer Security between a first service and a second service responsive to a data flow being marked between the first service and the second service.

At block 470, extend default policies of the threat aware service mesh by considering the threat model details.

At block 480, perform risk-based isolation in the threat aware service mesh.

In an embodiment, block 480 can include block 480A.

At block 480A, impose an isolation on one or more services responsive to one or more time limited and/or persistent risks.

At block 490, perform rule-based automatic isolation for risky services having an associated risk level above a threshold.

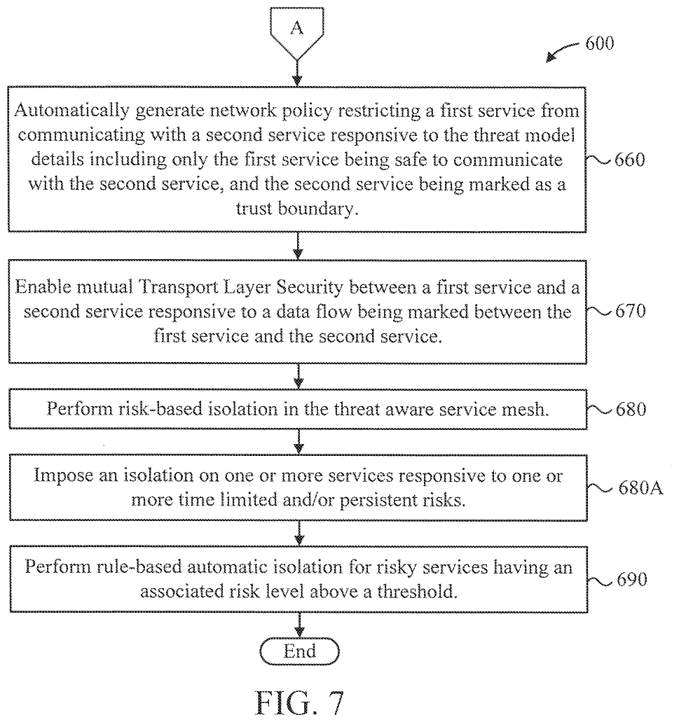

FIGS. 6-7 are flow diagrams showing another exemplary method 600 for providing a threat aware service mesh, in accordance with an embodiment of the present invention.

At block 610, maintain a threat model for the threat aware service mesh. The threat model can include, for each of a plurality of services, a service name, threat details, a remediation plan, risk details, and trust boundary details.

At block 620, extend the threat aware service mesh with a service mesh API and threat model management system in a control plane of the threat aware service mesh.

At block 630, automatically re-arrange a network policy related to a given service responsive to a high severity vulnerability above a threshold and an associated threat probability being marked against the given service. The re-arrangement can involve, for example, restricting the service from communicating with other services.

At block 640, perform a threshold based optimization of removing a particular service from a network policy allowed list responsive to one or more threats against the particular service at one of more different threat levels above a threshold. For example, the particular service could have a high severity threat level or 2 medium severity threat levels that could cause block 440 to be performed.

At block 650, assign default not-allowed policies and only allow access to restricted services for trust boundaries marked in a threat model of the threat aware service mesh.

In an embodiment, block 650 can include block 650A.

At block 650A, automatically generate network policy restricting a first service from communicating with a second service responsive to the threat model details including only the first service being safe to communicate with the second service, and the second service being marked as a trust boundary.

At block 660, enable mutual Transport Layer Security between a first service and a second service responsive to a data flow being marked between the first service and the second service.

At block 670, extend default policies of the threat aware service mesh by considering the threat model details.

At block 680, perform risk-based isolation in the threat aware service mesh.

In an embodiment, block 680 can include block 680A.

At block 680A, impose an isolation on one or more services responsive to one or more time limited and/or persistent risks.

At block 690, perform rule-based automatic isolation for risky services having an associated risk level above a threshold.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for providing a threat aware service mesh, comprising:
extending the threat aware service mesh to accept, in a control plane of the threat aware service mesh, a plugin threat modeling management resource for managing threat model details;
automatically re-arranging a network policy related to a given service responsive to a high severity vulnerability above a threshold and an associated threat probability being marked against the given service;
performing a threshold based optimization of removing a particular service from a network policy allowed list responsive to one or more threats against the particular service at one of more different threat levels above a threshold; and
assigning default not-allowed policies and only allowing access to restricted services for trust boundaries marked in a threat model of the threat aware service mesh.

2. The computer-implemented method of claim 1, wherein said extending step comprises configuring the threat aware service mesh to push threat model information received from the plugin threat modeling management resource to the control plane.

3. The computer-implemented method of claim 1, wherein said assigning step comprises automatically generating network policy restricting a first service from communicating with a second service responsive to the threat model details comprising only the first service being safe to communicate with the second service, and the second service being marked as a trust boundary.

4. The computer-implemented method of claim 1, further comprising enabling mutual Transport Layer Security between a first service and a second service responsive to a data flow being marked between the first service and the second service.

5. The computer-implemented method of claim 1, further comprising extending default policies of the threat aware service mesh by considering the threat model details.

6. The computer-implemented method of claim 1, further comprising performing risk-based isolation in the threat aware service mesh.

7. The computer-implemented method of claim 6, wherein the risk-based isolation imposes an isolation on one or more services responsive to one or more time limited risks.

8. The computer-implemented method of claim 1, wherein an application employing the threat aware service mesh comprises a first service, a second service, and a new third service for communicating with the first service and the second service, and wherein the threat aware service mesh isolates network policies common for all receiving services that receive traffic from the first service, and applies the second service to the new third service.

9. The computer-implemented method of claim 1, further comprising performing rule-based automatic isolation for risky services having an associated risk level above a threshold.

10. The computer-implemented method of claim 1, further comprising maintaining a threat model for the threat aware service mesh that comprises, for each of a plurality of services, a service name, threat details, a remediation plan, risk details, and trust boundary details.

11. A computer-implemented method for providing a threat aware service mesh, comprising:
extending the threat aware service mesh with a service mesh Application Programming Interface (API) and threat model management system in a control plane of the threat aware service mesh;
automatically re-arranging a network policy related to a given service responsive to a high severity vulnerability above a threshold and an associated threat probability being marked against the given service;
performing a threshold based optimization of removing a particular service from a network policy allowed list responsive to one or more threats against the particular service at one of more different threat levels above a threshold; and
assigning default not-allowed policies and only allowing access to restricted services for trust boundaries marked in a threat model of the threat aware service mesh.

12. The computer-implemented method of claim 11, wherein said assigning step comprises automatically generating network policy restricting a first service from communicating with a second service responsive to the threat model details comprising only the first service being safe to communicate with the second service, and the second service being marked as a trust boundary.

13. The computer-implemented method of claim 11, further comprising enabling mutual Transport Layer Security between a first service and a second service responsive to a data flow being marked between the first service and the second service.

14. The computer-implemented method of claim 11, further comprising extending default policies of the threat aware service mesh by considering the threat model details.

15. The computer-implemented method of claim 1, further comprising performing risk-based isolation in the threat aware service mesh.

16. The computer-implemented method of claim 15, wherein the risk-based isolation imposes an isolation on one or more services responsive to one or more time limited risks.

17. The computer-implemented method of claim 11, wherein an application employing the threat aware service mesh comprises a first service, a second service, and a new third service for communicating with the first service and the second service, and wherein the threat aware service mesh isolates network policies common for all receiving services that receive traffic from the first service, and applies the second service to the new third service.

18. The computer-implemented method of claim 11, further comprising performing rule-based automatic isolation for risky services having an associated risk level above a threshold.

19. The computer-implemented method of claim 11, further comprising maintaining a threat model for the threat aware service mesh that comprises, for each of a plurality of services, a service name, threat details, a remediation plan, risk details, and trust boundary details.

20. A computer program product for providing a threat aware service mesh, the computer program product comprising a non-transitory computer readable storage medium having program instructions embodied therewith, the program instructions executable by a computer to cause the computer to perform a method comprising:
extending, by a hardware processor of the computer, the threat aware service mesh to accept, in a control plane of the threat aware service mesh, a plugin threat modeling management resource for managing threat model details;
automatically re-arranging, by the hardware processor, a network policy related to a given service responsive to a high severity vulnerability above a threshold and an associated threat probability being marked against the given service;
performing, by the hardware processor, a threshold based optimization of removing a particular service from a network policy allowed list responsive to one or more threats against the particular service at one of more different threat levels above a threshold; and
assigning, by the hardware processor, default not-allowed policies and only allowing access to restricted services for trust boundaries marked in a threat model of the threat aware service mesh.
